(19) United States
(12) Patent Application Publication
(10) Pub. No.: US 2011/0090762 A1
(43) Pub. Date: Apr. 21, 2011

(54) Underwater navigation system

(76) Inventors: Mark Rhodes, West Lothian (GB); Brendan Hyland, Edinburgh (GB); Brian Kearns, Dublin (IE)

(21) Appl. No.: 12/582,965

(22) Filed: Oct. 21, 2009

(51) Int. Cl. H04B 11/00

(52) U.S. Cl. 367/131

(57) ABSTRACT

The present invention provides an underwater navigation system which can determine the bearing and the range of a remotely located beacon from a navigation station. The remotely located beacon transmits a pair of signals each having a different propagation velocity. Typically, the pair of signals are an acoustic signal and an electromagnetic signal. The range of the beacon to the navigation station is determined by a time differential in the detection of the two signals at the navigation station. The time differential is alternately a variation in phase between the two signals, or a time difference between the reception of a timing event encoded in synchronization on the pair of signals. In one form, the navigation station is a mobile unit which navigates to the remotely located beacon, and in another form the navigation station has a fixed position, and the remotely located beacon is mobile.

### FIELD OF USE

The present invention relates to the field of underwater navigation.

### DESCRIPTION OF THE RELATED ART

Systems that provide accurate means for navigation, ranging and homing underwater are vital for underwater exploration, oil exploration, seismic surveying and several other underwater and subsea fields of endeavor.

A navigation system based on the propagation of sonar is taught in U.S. Pat. No. 4,025,895; “Navigation System for Maneuvering a Structure about a Submerged Object”; Shatto.

The visible region of the electromagnetic spectrum also has been used for underwater navigation. Optical beacons can provide a good method for direction determination in a clear water environment, but are unsuitable for use in conditions of high turbidity. In particular, optical range finding, for example by triangulation of an optical signal emitted by a locating beacon, is only suitable for close range positioning and becomes progressively less accurate when the distance between the beacon and a corresponding navigation station increases.

U.S. Pat. No. 5,970,024, “Acousto-Optic Weapon Location System and Method”, Smith, teaches a system for underwater navigation comprising both acoustic and optical systems, and where one of the systems acoustic/optical is selected depending on the environment or the range etc.

Prior art underwater navigation systems based on the propagation of mechanical waves: E.G, sonar, or acoustic signaling, suffer from several limitations. A significant problem with prior art underwater navigation systems is the lack of an independent timing reference. Because of the absence of an independent timing reference, prior art underwater navigation systems are typically based on round trip timing. A method for determining range based on round trip timing typically involves transmitting a signal, receiving a reflected signal at some time later and determining the range of the reflecting target based on the delay between signal transmission and signal reception. Such acoustic systems are suitable for producing a profile of the sea-bed etc; however, they do not easily facilitate the location of a specific underwater target by a mobile navigating station. For example, a passive reflection from one target cannot easily be distinguished from a passive reflection from another target, so the system fails where there are multiple targets located within range of the navigating station. Moreover, round trip systems become complicated when more than one navigating station is searching for a given target; in this case the signals from each navigating station interfere with other.

Another limitation of underwater acoustic navigation systems is that they require an accurate estimate of the speed of sound in water to determine range. In fact, the speed of sound in water varies substantially with the local conditions of the water: temperature, salinity etc, so a range calculation will be limited by the accuracy of the value used for the speed of sound propagation.

### SUMMARY OF THE INVENTION

An improved system for underwater navigation would enable one or more navigating stations to navigate to a specific target. Where there are multiple navigating stations, the navigating stations would operate independently of each other. Such an improved system would be operable to determine the range of a navigating station from a given target without any need for the one or more navigating stations to transmit an interrogating signal or pinging signal to locate the target and would function regardless of whether the navigating stations are within a range of reception of signals transmitted by each other. An improved underwater navigation system would further enable a plurality of navigating stations to find one of a plurality of targets, spaced according to the requirements of the system.

Accordingly, it is an object of the present invention to provide underwater navigation system capable of determining the range of a remotely located target, where the target is identified by a transmitting beacon. The navigation system of the present invention is operable to determine the difference in the arrival time of a timing event which is encoded on a pair of signals transmitted by the remotely located transmitting beacon where each signal has a different propagation velocity. The navigation system of the present invention is capable of determining the range of the remotely located transmitting beacon to a high level of precision.

A second object of the present invention is to provide an underwater navigation system capable of determining the direction of a remotely located transmitting beacon. Direction is determined using a plurality receiving nodes comprising one or more signal receiving devices.

In some embodiments, the navigation system of the present invention is operable to determine the propagation velocity of a signal being transmitted by the remotely located transmitting.

The region of the electromagnetic spectrum commonly referred to as the radio spectrum is typically defined as the portion of the electromagnetic spectrum ranging from a few Hertz to a few hundred gigahertz. The propagation velocity of a radio signal in water varies according to the frequency and the salinity of the water. For seawater, having an electrical conductivity of 4 Siemens per metre, the propagation velocity of a radio signal is given by the approximate relationship: speed=1581 √frequency. On the other hand, the propagation speed of an acoustic or sound wave in seawater is approximately 1,500 metres per second. Thus for a radio signal with a frequency of 10 kHz, the propagation speed is approximately one hundred times greater than that of an acoustic wave.

According to a first aspect of the present invention, there is provided a navigation system comprising a transmitting beacon which transmits first and second signals, the first and second signals being transmitted in synchronization and having respective first and second propagation velocities. The magnitudes of the first and second propagation velocities are different so that a time differential between the first and second signals develops with distance from the transmitting beacon. The navigation system of the present invention further comprises a navigating station having a first receiving node where the first receiving node comprises first and second receiving devices for respectively receiving the first and second signals.

During use, a time differential between the first and seconds signal is determined from measured data of the first and second receiving devices of the first receiving node. The range of the transmitting beacon from the navigating station is determined from the time differential between the first signal and the second signal.

In typical embodiments, the range of the transmitting beacon from the navigating station is determined by the following relationship

$$\frac{{v}_{2} {v}_{1}}{( {v}_{2} - {v}_{1} )} Δ t = s$$

where S is the range, V₁ is the magnitude of the propagation velocity of the first signal, V₂ is the magnitude of the propagation velocity of the second signal, and where Δt is the time differential between the first signal and the second signal.

In other embodiments, the navigation system of the present invention comprises second and third receiving nodes, each of the second and third receiving node comprising receiving devices for detecting the first signal and/or the second signal. The second and third receiving nodes are spatially separated from the first receiving node, preferably in such a way so that lines extending from the first receiving node to the second receiving node and from the first receiving node to the third receiving node are perpendicular.

The receiving devices of the first, second and third receiving nodes may be directional devices, alternatively, omnidirectional receiving devices may be employed.

A two dimensional bearing of the transmitting beacon relative to the first receiving node of the navigation station of the present invention can be determined from time data of the first or second signals measured by the first, second and third receiving nodes. Such time data might be a time differential of the first and second signals at each of the receiving nodes, or may be an absolute time of arrival of the first or the second signal at each of the receiving nodes.

Preferably, the first signal is an acoustic signal and the second signal is an electromagnetic signal in the frequency range from 10 Hz to 10 MHz. Alternatively, the first signal may be either an acoustic signal or an electromagnetic signal in the frequency range from 10 Hz to 10 MHz and the second signal may be an optical signal in the visible region of the electromagnetic spectrum. Further alternatively, both first and second signals may be electromagnetic signals in the radio spectrum.

The propagation velocities of the first and second signals V₁ and V₂ may be determined from time data of the first and second signals measured by the first, second and third receiving nodes.

In alternative embodiments, the navigation system of the present invention comprises a fourth receiving node having receiving devices for receiving the first signal and/or the second signal. In such embodiments, a three dimensional direction of the transmitting beacon relative to the navigation station is determined from measured data of the first, second, third and fourth receiving nodes.

The synchronization of the first and second signals may be a synchronization of the phase of each of the signals. Alternatively, the synchronization of the first and second signals of the navigation system of the present invention may be a synchronization of a timing event encoded on each of the signals. Such a timing event may be a phase modulation of the carrier of each signal or may be a leading edge of a pulse modulated on each signal. Alternatively, a given modulating sequence, for example a binary string, may be encoded on the first and second signals. Such a modulating sequence may be a pseudorandom binary sequence (PRBS). The time differential between the first and second signals in this case is determined by adding a variable delay to one of the signals in the receiving node, and by adjustment of this delay until the two signals correlate.

In some embodiments, the first and second signals are transmitted using carrier signals having the same frequency.

In typical embodiments, the transmitting beacon of the present invention, transmits the first and second signals periodically; this allows the reduction of energy usage by the transmitting beacon.

Specifically, the transmitting beacon may be designed to become active only when the navigation station is within the range of reception of the first and second signals. In one embodiment, the transmitting beacon becomes active only after it has received a handshaking signal from the navigating station.

According to a second aspect of the present invention, there is provided a navigation system comprising a plurality of transmitting beacons which transmit first and a second signals, the first and second signals being transmitted in synchronization and having respective first and second propagation velocities. The navigation system further comprises a navigating station having a first receiving node where the first receiving node comprises first and second receiving devices for respectively receiving the first and second signals.

Preferably, the first and second signals transmitted by the plurality of transmitting beacons are transmitted using an identifying property so that the first and second signals of each of the plurality of transmitting beacons can be distinguished from each other.

The identifying property of the first and second signals from each of the plurality of transmitting beacons may, for example, be the frequency of carriers of both signals. Alternatively, the identifying property may be a pre-programmed binary sequence specific to each of the plurality of transmitting beacons.

Preferably, each transmitting beacon is designed to become active only when the navigation station is within the range of reception of the first and second signals, for example, so that a given transmitting beacon becomes active only after it has received a handshaking signal from the navigating station.

### BRIEF DESCRIPTION OF DRAWINGS

FIG. 1 shows a diagram illustrating a navigation system according to an embodiment of the present invention for determining bearing and range in a two dimensional space.

FIG. 2 shows a diagram of a method for determining bearing in a two dimensional navigation system according to the present invention.

FIG. 3 shows the variation in a time differential between a pair of signals with distance from a source where the pair of signals have the same frequency but propagate with two different velocities.

FIG. 4 shows a block diagram of a transmitting beacon of the navigation system of FIG. 1.

FIG. 5 shows a block diagram of one of the receiver nodes of the navigating station of FIG. 1.

FIG. 6 shows a block diagram of a transmitting beacon of the navigation system according to a second embodiment of the present invention.

FIG. 7 shows a block diagram of a receiver node which receives first and second signals from the transmitting beacon of FIG. 6.

FIG. 8 shows a block diagram of a transmitting beacon of the navigation system according to a third embodiment of the present invention.

FIG. 9 shows a block diagram of a receiver node which receives first and second signals from the transmitting beacon of FIG. 8.

FIG. 10 shows a diagram of a method for determining direction in a three dimensional navigation system according to the present invention.

FIG. 11 shows a diagram illustrating a navigation system comprising a plurality of transmitting beacons according to the present invention.

### DETAILED DESCRIPTION

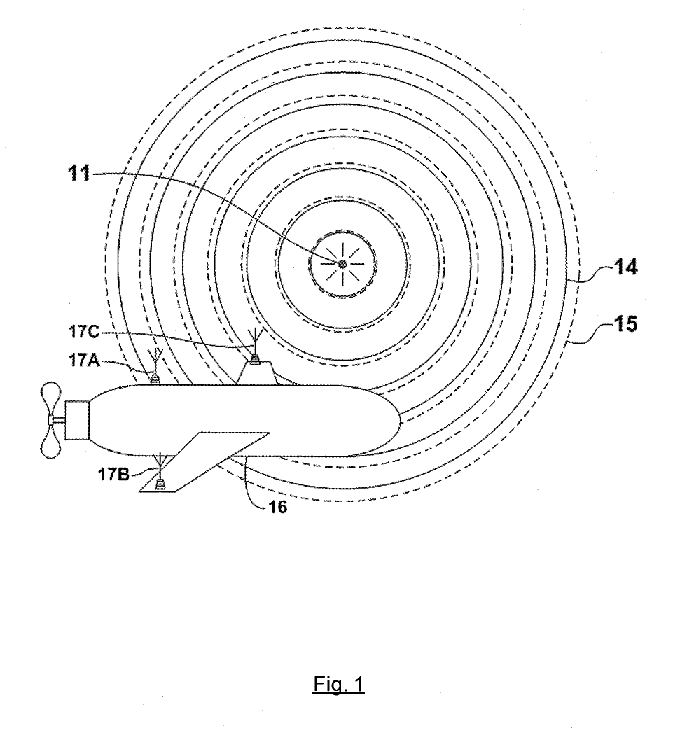

FIG. 1 shows a diagram of an underwater navigation system according to a first embodiment of the present invention. The underwater navigation system of the FIG. 1 comprises transmitting beacon 11, and a navigating station 16. Transmitting beacon 11 transmits a first signal 14 and a second signal 15, where the first and second signals 14, 15 have respective propagating velocities V₁ and V₂. Transmitting beacon 11 is located remotely from underwater navigating station 16. Typically, navigating station 16 is a mobile unit, and transmitting beacon 11 has a fixed location, for example, to mark the location of a data access point in an underwater or subsea installation. Transmitting beacon 11 is operable so that first signal 14 and second signal 15 are transmitted in synchronization. As shown in the diagram of FIG. 1, propagating velocity V₁ of first signal 14 is less than propagating velocity V₂ of second signal 15, so that as the signals travel away from the source, i.e. transmitting beacon 11, a progressive time delay develops between the two signals. Navigating station 16 comprises receiving nodes 17A, 17B and 17C. The first and second signals of transmitting beacon are received at receiving nodes 17A, 17B and 17C. At least one of receiving nodes 17A, 17B, and 17C comprise first and second signal receiving devices for receiving the first and second signals of transmitting beacon 11 and the other receiving nodes comprise a receiving device for receiving the first signal of transmitting beacon 11. Receiving nodes 17A, 17B and 17C are represented in FIG. 1 as units each comprising a single radio antenna for the purpose of illustration only, and may comprise multiple receiving devices as described in the embodiments of the present invention herein.

The range S of transmitting beacon 11 from navigating station 16 can be determined based on the following relationships for the two signals propagating underwater:

s=v₁t₁S=V₁×t₁ . . . first signal, slow signal; EQ. 1

s=v₂t₂S=V₂×t₂ . . . second signal, fast signal; EQ. 2

Δt=t₁−t₂Δt=t₁−t₂ . . . time differential between signals as determined by measurement of arrival time of each signal at navigating station 16. EQ. 3

An expression for the range S_{A,B,C} of transmitting beacon from any one of receiving nodes 17A, 17B or 17C is determined as follows:

s=v₁(t₂Δt) . . . from EQ. 1 EQ. 4A

s=v₁(t₂+Δt) . . . from EQ. 2 EQ. 4B

s=v₁(t₂+Δt) . . . substitution of EQ. 3 into EQ. 1 EQ. 5

Where t_{1A,1B,1C} is the time or arrival of the first signal at receiving node 17A, 17B or 17C, t_{2A,2B,2C} is the time or arrival of the second signal at receiving node 17A, 17B or 17C and Δt_{A,B,C} is the differential in the arrival time of the first and second signals at receiving node 17A, 17B or 17C.

Rearranging EQ. 4B and EQ. 5 gives the following expression for the range S_{A,B,C} of transmitting beacon from any one of receiving nodes 17A, 17B or 17C:

$$\frac{{v}_{2} {v}_{1}}{( {v}_{2} - {v}_{1} )} Δ t = s \qquad EQ . 6$$

Thus, if propagating velocities V₁ and V₂ are known, the range S_{A,B,C} of transmitting beacon from any one of receiving nodes 17A, 17B or 17C can be determined from the differential in the arrival time of the first and second signals.

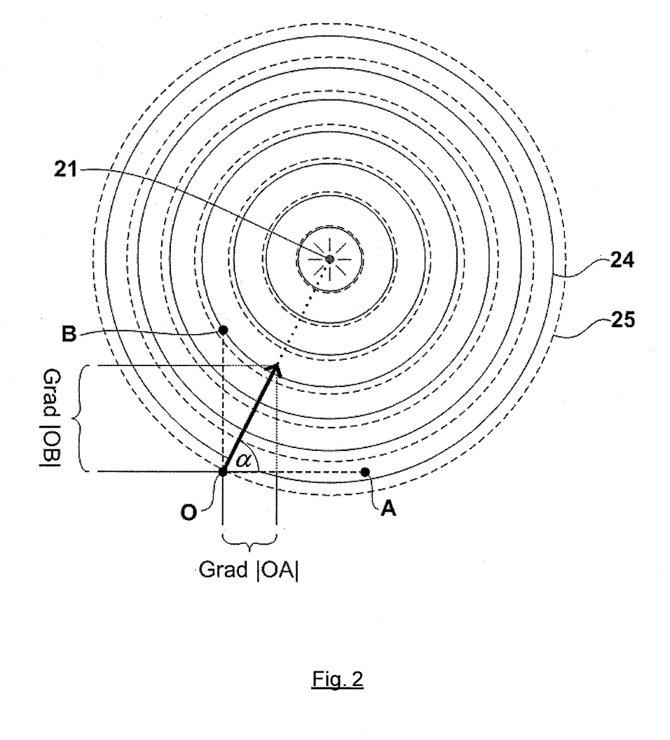

FIG. 2 shows a diagram of a system for determining a two dimensional direction or bearing of transmitting beacon 21 of the underwater navigation system according to an embodiment of the present invention. The system for determining direction of FIG. 2 comprises a transmitting beacon 21 which transmits a first signal 24 and a second signal 25, where the first and second signals have respective propagating velocities V₁ and V₂. The system for determining direction further comprises receiving nodes, O, A and B, remotely located from transmitting beacon 21. Receiving nodes O, A and B comprise receiving devices for receiving first signal 24 and/or second signal 25. Receiving nodes O, A and B might be mounted on a mobile underwater unit (not shown) as exemplified by navigating station 16 of FIG. 1. Receiving nodes O, A and B are arranged so that a pair of line segments |OA| and |OB| are formed, where line segment |OA| extends between receiving nodes O and A, and line segment |OB| extends between receiving nodes O and B. Preferably, line segments, |OA| and |OB| are perpendicular to each other; however it is sufficient that line segments, |OA| and |OB| are, at least, not collinear with each other. Line segments, |OA| and |OB| together form a pair of axes against which components of a vector quantity can be resolved. A direction of maximum gradient of a given property of the first and/or second signals can be determined by examining the components of the gradient of the same property of the signals along line segments, |OA| and |OB| respectively. For the specific case where line segments, |OA| and |OB| are perpendicular to each other, as shown in FIG. 2, the direction of maximum gradient is given by the expression of EQ. 7

$$\frac{{v}_{2} {v}_{1}}{( {v}_{2} - {v}_{1} )} Δ t = s \qquad EQ . 7$$

Any property of the first and/or second signals which varies isotropically with distance from the transmitting beacon 21, is a suitable property for determination of the direction of transmitting beacon 21 relative to receiving node O. For such a property, the direction of maximum gradient at receiving node O is the same as the direction of transmitting beacon 21 relative to receiving node O. For example, a suitable property might be the time differential between the first and second signals. It can be seen from FIG. 2 and equations 1, 2 and 3 that this property of the first and second signals increases with distance from the source 21 and is not dependent on the direction of signal propagation. Thus, the component of the gradient can be determined along line segments |OA| and |OB| and the results can be substituted into equation 7 to give the direction of transmitting beacon 21 relative to receiving node O.

Other properties of the signals which may be used to determine direction include, but are not limited to, the time of arrival of a timing event of the first or second signal at receiver nodes O, A and B, the phase of the first or second signals at receiver nodes O, A and B, the arrival time of a leading edge of a pulse modulated on the first or second signals at receiver nodes O, A and B.

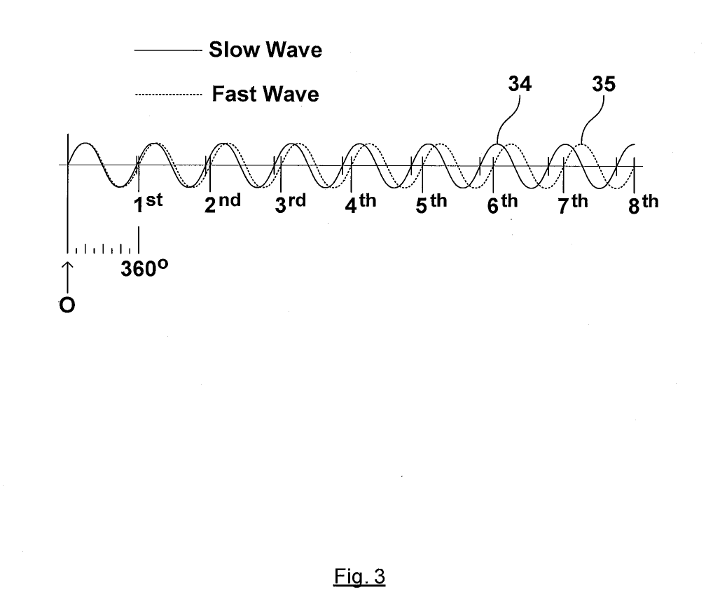

FIG. 3 shows a diagram illustrating the variation of a differential between a first signal 34 propagating with a first propagation velocity, and a second signal 35 propagating with a second propagation velocity from a source O. In the diagram of FIG. 3, the propagation velocity of first signal 34 is slower than that of second signal 35. Both signals are in phase at the source O. After a full sinusoidal cycle of both signals, second signal 35 leads first signal 34 by a value of π/16 radians or 11.25 degrees; after two full cycles, second signal 35 leads first signal 34 by a value of π/8 radians or 22.5 degrees. As the first and second signals propagate with distance from source O, the time differential between the signals increases so that after 8 full cycles of both signals, second signal 35 leads first signal 34 by a value of π/2 radians or 90 degrees.

The time differential between first signal 14 and second signal 15 of the embodiment of the present invention depicted in FIG. 1 can be determined from a range of properties of both signals. For example, the phase difference between the first and second signals can be used to calculate a time differential. Alternatively, the same timing event can be encoded on each signal so that the time differential between both signals is the difference in the arrival time of the encoded timing event at one of receiving nodes 17A, 17B or 17C. Such a timing event might be a rising edge of a pulse, or may be the time of a discrete change in phase of the first and second signals, as would be typical of systems employing binary phase shift keying (BPSK) or quadrature phase shift keying (QPSK). In any event, the essential property of the first and second signals 14, 15 of the navigation system of FIG. 1 is that there are two different propagation velocities V₁ and V₂, so that a time differential between the two signals increases with distance from the transmitting beacon 11.

In common use, the transmitting beacon 11 of the embodiment of the present invention of FIG. 1, transmits the first and second signals 14, 15 periodically thereby facilitating a reduction in energy usage by the transmitting beacon.

Optionally, the transmitting beacon 11 may be designed to become active only when the navigation station 16 is within the range of reception of the first and second signals 14, 15. For example, the transmitting beacon 11 may be programmed to become active only after it has received a handshaking signal from navigating station 16. In addition to the benefits of reduced power consumption, this feature facilitates the navigation system of the present invention to operate covertly.

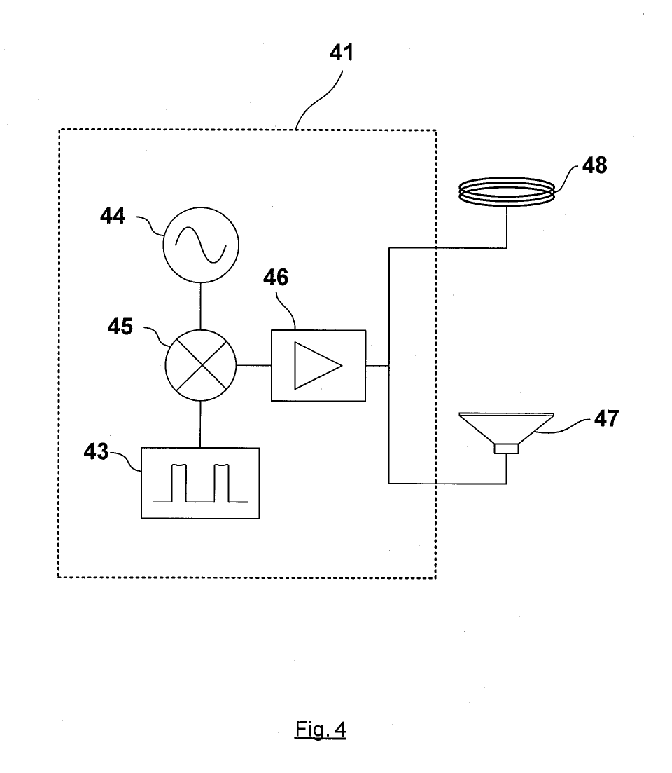

FIG. 4 shows a block diagram of one possible configuration of the transmitting circuitry and output transducers of transmitting beacon 11 of the embodiment of the present invention depicted in FIG. 1. The transmitting circuitry 41 comprises modulator 43 and oscillator 44. An output signal from oscillator 44 is typically a single frequency carrier signal. The output signal from oscillator 44 is fed to mixer 45. An output signal from modulator 43 is also fed to mixer 45 so that the carrier signal output from oscillator 44 is modulated by the signal from modulator 43. A number of suitable modulation schemes for modulation signal 43 are available, as would be obvious to a person skilled in the art. For example, the modulation signal may be a pulse of short duration which is repeated periodically with a low duty cycle, so as to produce a pulsed output from mixer 45. Alternatively, the modulation signal may be a square wave pulse. The square wave pulse may alternate from normalized values of 0 to 1 so as to provide an output signal from mixer 45 encoded according to an Amplitude Shift Keying (ASK) modulation scheme or may alternate from normalized values of −1 to +1 so as to provide an output signal from mixer 45 encoded according to a Binary Phase Shift Keying (BPSK) modulation scheme. The output signal from mixer 45 is amplified by power amplifier 46 and is fed to output transducers 47 and 48. Output transducer 47 is an acoustic transducer which excites mechanical and/or acoustic vibrations when driven by an electrical signal so that a first signal is transmitted by transducer 47. Output transducer 48 is an antenna suitable for generating an electromagnetic signal underwater; hence, a second signal is transmitted by transducer 48. A preferred form of antenna 48 is an electrically insulating loop antenna, this type of antenna being highly suitable for producing magnetic signals in the Super Low Frequency (SLF) range, the Ultra Low Frequency (ULF) range, and Very Low Frequency (VLF) range which can propagate over greater distances underwater. In addition to the transmission circuitry 41, baseband circuitry, power circuitry and other circuitry may be included in transmitting beacon 11 so as to provide the required output signals. Such additional circuitry is well known in the art and is not described herein.

Typically, the first signal transmitted by output transducer 87 is an acoustic signal, and the second signal is an electromagnetic signal having a carrier frequency in the range from 100 Hz to 10 kHz. The propagation velocity of an electromagnetic signal with a frequency ranging from 100 Hz to 10 kHz in sea water is in the order of 50,000 metres/sec. On the other hand, the propagation velocity of an acoustic signal is 1500 metres/sec; thus the first and second signals of have the required different propagation velocities for range determination according to the present invention.

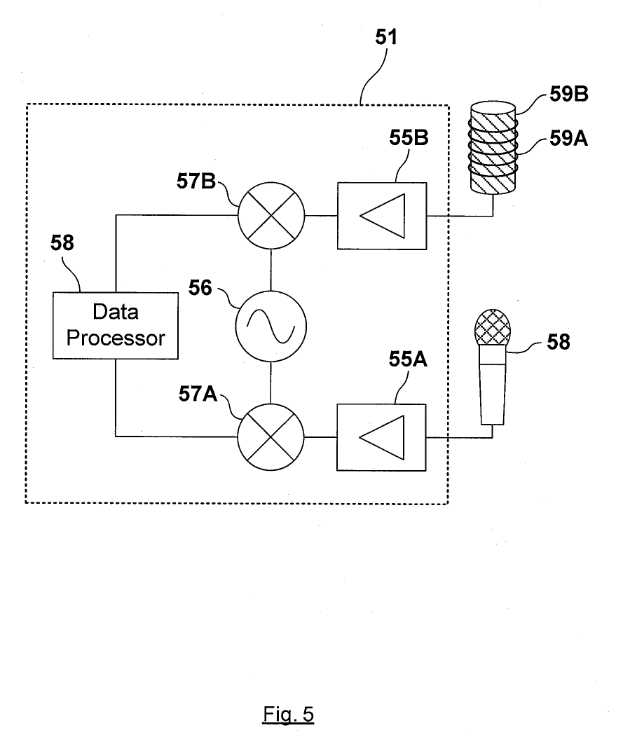

FIG. 5 shows a block diagram of a possible configuration of the receiving circuitry and receiving devices of one of receiving nodes 17A, 17B or 17C of the embodiment of the present invention depicted in FIG. 1. The first signal from transmitting beacon 11 of FIG. 1 is received by hydrophone 58; the second signal from transmitting beacon 11 of FIG. 1 is received by a magnetic antenna which comprises several turns of electrically conductive wire 59A wound around a cylindrical core 59B of a material with a high magnetic permeability. The first and second received signals are passed to receiver circuitry 51. The receiving circuitry 51 comprises low noise amplifiers (LNA) 55A and 55B which respectively amplify the first and second received signals. Oscillator 56 generates a reference signal with the same frequency as that of the carrier of first and second signals of transmitting beacon 11. Outputs from oscillator 56 are fed to mixer 57A and mixer 57B so that demodulated signals of the first and second signals are output respectively from mixer 57A and mixer 57B. These demodulated signals are then fed to data processor 58 where a time differential of the first and second signals is determined.

If required, the navigation system of an embodiment of the present invention depicted in FIG. 1 can be used to determine the respective first and second propagating velocities V₁ and/or V₂ of the first and second signals. The method for velocity determination is similar to the direction determination procedure described herein and depicted in FIG. 2. Components of a velocity vector are calculated by determining the time difference of reception of a timing event of a signal along axes |OA| and |OB| respectively and then by dividing the result into the respective lengths of line segments |OA| and |OB|. The magnitude of the propagation velocity of the signal is then determined geometrically; for example, when line segments |OA| and |OB| are perpendicular, the magnitude is determined by the Pythagoras theorem.

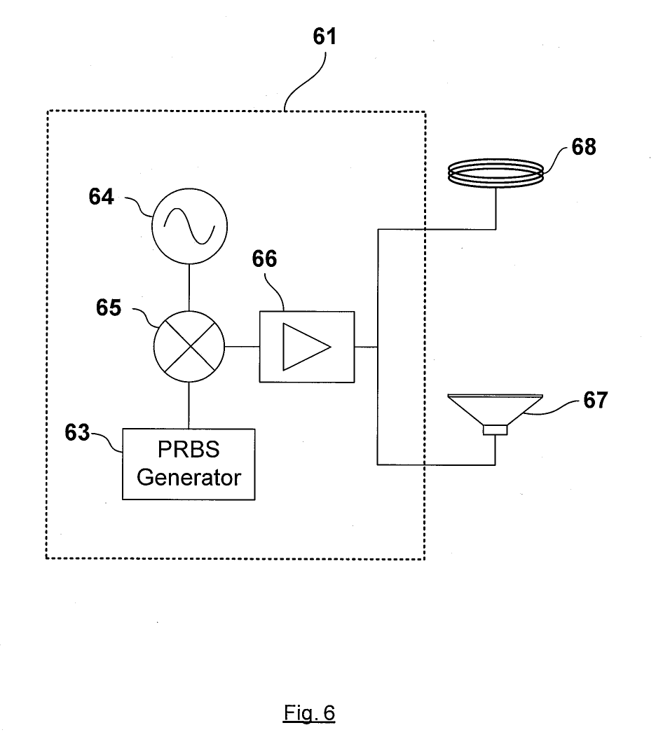

FIG. 6 shows a block diagram of a configuration of transmitting circuitry and output transducers of a transmitting beacon according to a second embodiment of the present invention. The transmitting circuitry 61 comprises Pseudo Random Binary Sequence (PRBS) generator 63 and oscillator 64. A single frequency carrier signal is output from oscillator 64 and is fed to mixer 65. An output from PRBS generator 63 is also fed to mixer 65 so that the carrier signal output from oscillator 64 is modulated by the PRBS signal. The modulated output signal from mixer 65 is amplified by power amplifier 66 and is fed to output transducers 67 and 68. Output transducer 67 is an acoustic transducer which excites acoustic vibrations when driven by an electrical signal so that a first signal is transmitted by output transducer 67. Output transducer 68 is an antenna suitable for generating an electromagnetic signal underwater and hence a second signal is transmitted by transducer 68.

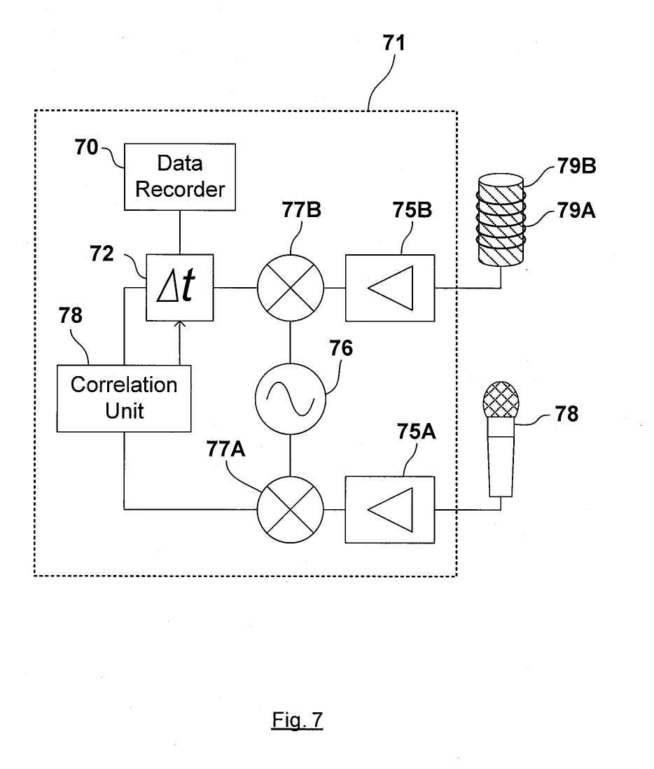

FIG. 7 shows a block diagram of a configuration of the receiving circuitry and receiving devices of a receiving node suitable for receiving the first and second signals transmitted by the transmitting circuitry of FIG. 6. The first signal is received by hydrophone 78; the second signal is received by a magnetic antenna comprising several turns of electrically conductive wire 79A wound around a cylindrical core 79B of a material with a high magnetic permeability. The first and second received signals are passed to receiving circuitry 71. Receiving circuitry 71 comprises LNA 75A and 75B which respectively amplify the first and second received signals. Oscillator 76 generates a reference signal with the same frequency as that of the carrier of first and second signals from transmitting circuitry 61 of FIG. 6. Outputs from oscillator 76 are fed to mixer 77A and mixer 77B so that demodulated signals of the first and second signals are output respectively from mixer 77A and mixer 77B. A variable time delay circuit 72 adds a time delay to the second demodulated signal; both first and second demodulated signals are then fed to correlation unit 78. Correlation unit 78 measures the correlation function of both demodulated signals, and provides a variable feedback control to time delay circuit 72. When the correlation of the two signals is optimized, the value of the delay added to the second demodulated signal is recorded by data recorder 70. This provides the required time differential for determining the range of the transmitting beacon from the receiving node, the range being determined in a manner similar to that outlined for the first embodiment of the present invention described herein. Similarly a two dimensional bearing can be determined according to the same procedure outlined herein and depicted in FIG. 2.

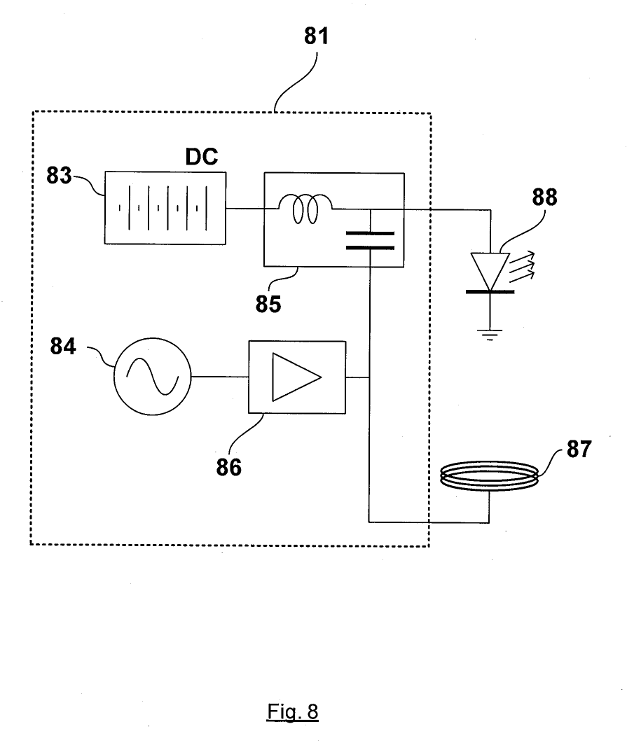

FIG. 8 shows a block diagram of a configuration of transmitting circuitry and output devices of a transmitting beacon according to a third embodiment of the present invention. The transmitting circuitry 81 comprises oscillator 84, power amplifier 86, DC power supply 83 and DC bias-tee network 85. A single frequency carrier signal is output from oscillator 84 and is fed to power amplifier 86. An output from power amplifier 86 and is fed to output transducer 87. Output transducer 87 is an antenna suitable for generating an electromagnetic signal underwater, for example a loop antenna comprising multiple turns of wire. Hence, a first signal is transmitted by output transducer 87. A second output from power amplifier 86 is fed Light Emitting Diode (LED) 88 via bias tee network 85. Bias tee network 85 provides a DC signal from DC power supply 83 which is combined with the output from power amplifier 86. The DC signal from DC power supply 83 is combined with the oscillating signal from the output of power amplifier 86 to provide a combined signal that causes the intensity of the light emitted by LED 88 to vary with time in the same manner and with the same frequency as that of the carrier signal emitted by oscillator 84. Thus, a second signal is transmitted by photodiode 88, the second signal being an electromagnetic signal in the visible region of the spectrum. A single LED is shown in the embodiment depicted in FIG. 8; alternatively a bank of LEDs may be used; further alternatively the output device may be any light emitting source suitable for transmitting a signal in the visible region of the electromagnetic signal underwater.

Typically, the first signal transmitted by output transducer 87 is an electromagnetic signal having a carrier frequency in the range from 100 Hz to 10 kHz. The propagation velocity of an electromagnetic signal with a frequency ranging from 100 Hz to 10 kHz in sea water is in the order of 50,000 metres/sec. On the other hand, the propagation velocity of an electromagnetic signal in the visible region of the electromagnetic spectrum is approximately 2×10⁸ metres/sec; thus the first and second signals of have the required different propagation velocities for range determination according to the present invention.

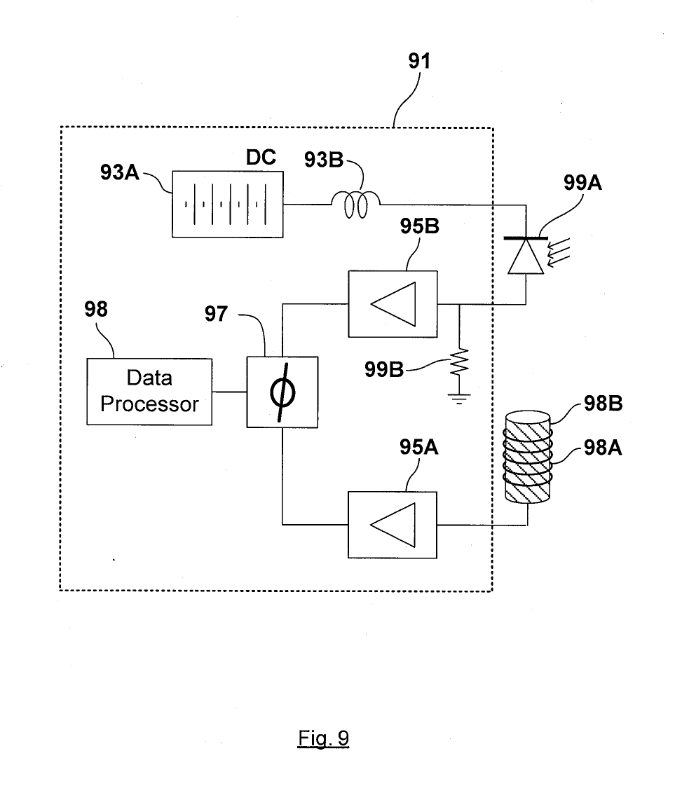

FIG. 9 shows a block diagram of a configuration of the receiving circuitry and receiving devices of a receiving node suitable for receiving the first and second signals transmitted by the transmitting circuitry of FIG. 8. The first signal is received by a magnetic antenna comprising several turns of electrically conductive wire 98A wound around a cylindrical core 98B of a material with a high magnetic permeability. The first received signal is then passed to LNA 95A, where it is amplified. The second signal is received by photodiode 99A. Photodiode 99A is supplied with a reversed biased DC signal via DC power supply 93A and inductor 93B. Sensing resistor 98B converts the photo current generated by photodiode 99A to a voltage which is amplified by LNA 95B. The first and second received signals are then passed to phase comparator 97 which compares the phase of the first and second received signals. The output from phase comparator 97 is passed to data processor which contains the required electronic circuitry to determine a time differential between the first and second signals.

The range of a transmitting beacon comprising the circuitry and output devices FIG. 8 from a navigating station comprising the receiving circuitry and receiving devices of FIG. 9 can be determined from the time differential between the first and second received signals in a manner similar to that outlined for the first embodiment of the present invention described herein. Similarly a two dimensional bearing can be determined according to the same procedure outlined herein and depicted in FIG. 2.

The propagation speed of a radio signal in seawater, having an electrical conductivity of 4 Siemens per metre, is given by the approximate relationship: speed=1581 √frequency. Thus, the propagation velocity of a radio signal can vary over a very wide range with frequency. Other embodiments of the present invention (not shown) comprise a transmitting beacon which transmits first and second signals in the radio spectrum, the first and second signals being received by a remotely located receiving node of a navigating station. Such embodiments involve the transmission of first and second signals, where the frequency of the second signal is sufficiently greater than that of the first signal so that a time differential between the first and second signals can be determined by the receiving node. For example, a factor of ten between the frequency of the second signal and the frequency of the first signal provides a factor of 3.16 in the propagation velocities of the second and first signals.

Other embodiments of the present invention may comprise combined elements of the first second and third embodiments described herein. For example, an alternative embodiment might include transmitting circuitry and output transducers to provide a first acoustic signal and a second optical signal. Range and bearing can be determined from a measured time differential between the first acoustic signal and the second optical signal in a manner similar to that outlined for the first embodiment of the present invention.

Embodiments of the present invention transmitting a second signal in the visible region of the electromagnetic spectrum are highly suited to underwater environments where good visibility is maintained over a long range.

On the other hand, embodiments transmitting a second signal in the VLF region of the electromagnetic spectrum are highly suited to underwater environments suffering from poor visibility. Poor visibility can be caused by physical obstructions in the path of propagation or can be caused by turbidity—a cloudiness or haziness caused by suspended particles in the water which are generally invisible to the naked eye.

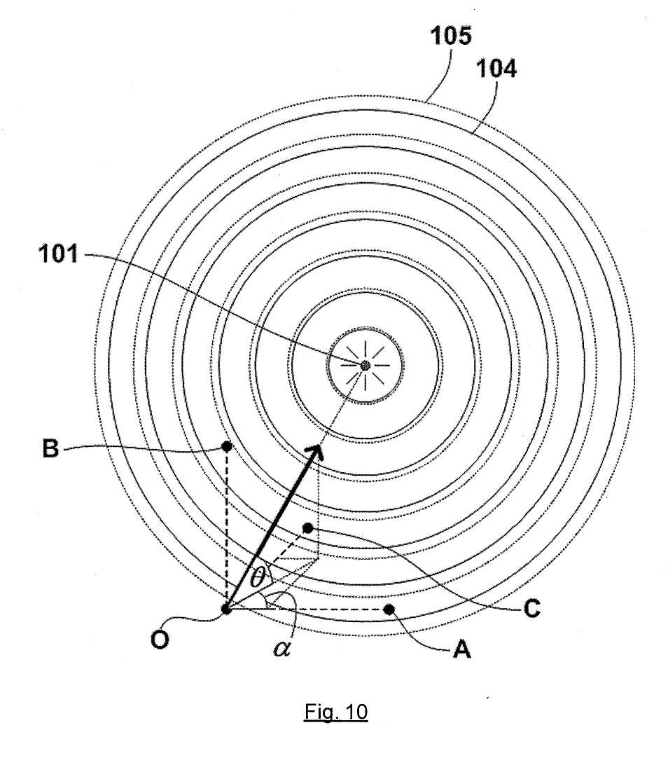

FIG. 10 shows a diagram of a system for determining a three dimensional direction of a transmitting beacon 101 from a given point of an underwater navigation system according to an embodiment of the present invention. The system for determining direction of FIG. 10 comprises a transmitting beacon 101 which transmits first and second signals 104, 105 having a first propagation velocity and a second propagation velocity. The system for determining direction further comprises receiving nodes O, A, B and C remotely located from transmitting beacon 101. Receiving nodes O, A, B and C comprise receiving devices for detecting the first signal 104 and/or the second signal 105. Receiving nodes O, A, B and C might be mounted on a mobile underwater unit (not shown) as exemplified by navigating station 16 of FIG. 1. Receiving nodes, O, A, B and C are arranged so that line segments |OA|, |OB| and |OC| are formed, where line segment |OA| extends between receiving nodes O and A, line segment |OB| extends between receiving nodes O and B and line segment |OC| extends between receiving nodes O and C. Preferably, line segments, |OA|, |OB| and |OC| are perpendicular to each other; however, for direction determination it is sufficient that none of the line segments |OA|, |OB| and |OC| are collinear with each other. Line segments |OA|, |OB| and |OC| together form a system of axes against which components of vector quantity can be resolved. A direction of maximum gradient of a given property of the transmitted signal 104 can be determined by examining the components of the gradient of the same property of the signal along line segments |OA|, |OB| and |OC| respectively. For the specific case where line segments |OA|, |OB| and |OC| are perpendicular to each other, as shown in FIG. 10, the direction of maximum gradient is given by the expressions of EQ. 8A and EQ 8B:

$$\begin{matrix}\frac{{v}_{2} {v}_{1}}{( {v}_{2} - {v}_{1} )} Δ t = s & EQ . 8 A \\ \frac{{v}_{2} {v}_{1}}{( {v}_{2} - {v}_{1} )} Δ t = s & EQ . 8 B\end{matrix}$$

Direction can be determined from any property of the first and/or second signals, such as arrival time of an timing event encoded on the first and/or second signal at receiving node O, A, B and C, or a time differential between the first and second signals determined at receiving node O, A, B and C.
The three directional direction determining system as described by FIG. 10 can be applied to any of the other embodiments of the present invention. In some practical applications, two dimensional direction determination may be sufficient, however, there is no reason why the present invention would be restricted to a system for determining a two dimensional direction of a transmitting beacon.

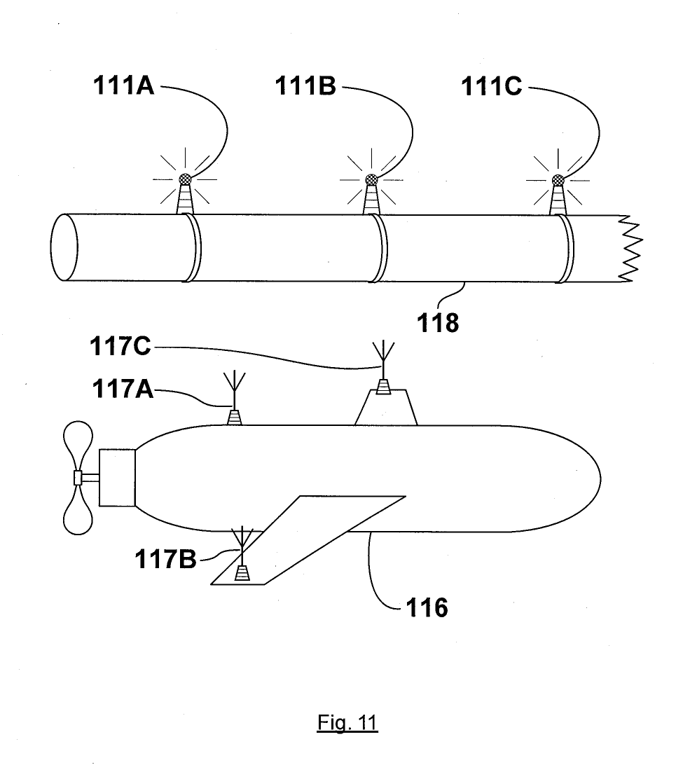

FIG. 11 shows a navigation system according to a fourth embodiment of the present invention comprising a plurality of transmitting beacons 111A, 111B and 111C, each transmitting first and second signals (not shown). The navigation system further comprises a navigating station 116. Transmitting beacons 111A, 111B and 111C are each located remotely from underwater navigating station 116. The first and second signals from each of the transmitting beacons 111A, 111B and 111C are transmitted in synchronization and have respective first and second propagation velocities. Transmitting beacons 111A, 111B and 111C are located at fixed intervals and positions along an underwater installation 118; for example an oil pipeline or a subsea drilling station. Navigating station 116 comprises receiving nodes 117A, 117B and 117C where at least one of the receiving nodes 117A, 117B and 117C comprises a first and a second receiving device for respectively receiving the first and the second signals of the transmitting beacons 111A, 111B and 111C, and where the other receiving nodes comprise a receiving device for receiving the first signal.

During use, a time differential between the first and second signals of at least one of the plurality of transmitting beacons 111A, 111B and 111C is determined from measured data of the first and second receiving devices. The range of navigating station 116 from the at least one of the plurality of transmitting beacons 111A, 111B and 111C is determined from the time differential in a manner similar to that outlined in the description of the first embodiment of the present invention.

Typically, the first and second signals transmitted from each of transmitting beacons 111A, 111B and 111C are transmitted with an identifying property so that the source of each pair of signals can be determined after the signal is decoded.

The identifying property of the first and second signals from a given transmitting beacon 111A, 111B and 111C may be the carrier frequency; alternatively, the identifying property of the first and second signals may take the form of a pre-programmed binary sequence specific to each of the plurality of transmitting beacons.

The position of navigating station 116 relative to the plurality of transmitting beacons 111A, 111B and 111C can be determined geometrically from the range of navigating station 116 from two or more transmitting beacons transmitting beacons 111A, 111B and 111C. For example, if the range of navigating station 116 from two of the transmitting beacons 111A, 111B is known and is given by R₁ and R₂ respectively, then the position of navigating station 116 must be on a locus of points defined by the intersection of the surfaces of a pair of spheres centered on transmitting beacons 111A and 111B, with radii of R₁ and R₂ respectively. If the range of navigating station 116 to a third transmitting beacon is known, the position of navigating station 116 is defined to a pair of points, in many cases this will define the position of navigating station 116 uniquely, as one of the points may be inaccessible (inside the seabed etc.) and if the range of navigating station 116 to a fourth transmitting beacon is know, then the position is defined uniquely. Thus the absolute position and trajectory of navigating station 116 can be determined from the values of the measured time differential of the first and second signals of three or more of transmitting beacons 111A, 111B and 111C.

In common use, transmitting beacons 111A, 111B and 111C of the embodiment of the present invention of FIG. 11, transmit first and second signals periodically so as to facilitating a reduction in energy usage.

Optionally, transmitting beacons 111A, 111B and 111C may each be designed to become active only when the navigation station 116 is within the range of reception of the first and second signals. For example, transmitting beacons 111A, 111B and 111C may each be programmed to become active only after they have received a handshaking signal from navigating station 116.

The underwater navigation systems and methods described herein are generally applicable to seawater, fresh water and any brackish composition in between. Since relatively pure fresh water environments exhibit different electromagnetic propagation properties from saline seawater, different operating conditions may be preferred in each environment. Any optimization required for specific saline constitutions will be obvious to a practitioner skilled in this area.

Moreover, the above descriptions of the specific embodiments is made by way of example only and not for the purposes of limitation. It will be obvious to a person skilled in the art that in order to achieve some or most of the advantages of the present invention, practical implementations may not necessarily be exactly as exemplified and can include variations within the scope of the present invention.

What is claimed is:

1. An underwater navigation system,
said navigation system comprising a beacon which transmits a first signal and a second signal, said first and second signals being transmitted in synchronization and having a respective first propagation velocity and second propagation velocity,
said navigation system further comprising a navigating station comprising a first receiving node,
where said first receiving node comprises a first and a second receiving device for respectively receiving said first and said second signal,
wherein, during use, a time differential between said first signal and said second signal is determined from measured data of said first and said second receiving device and wherein a range of said transmitting beacon from said navigating station is determined from said time differential between said first signal and said second signal.

2. An underwater navigation system according to claim 1 wherein said range of said transmitting beacon from said navigating station is determined by the following relationship
$$S = \frac{{V}_{2} {V}_{1}}{( {V}_{2} - {V}_{1} )} Δ t \frac{{v}_{2} {v}_{1`}}{( {v}_{2} - {v}_{1} )} Δ t = s$$
where S is said range, V₁ is said propagation velocity of said first signal, V₂ is said propagation velocity of said second signal, and where Δt is said time differential between said first signal and said second signal.

3. An underwater navigation system according to claim 1 further comprising second and third receiving nodes said second and third receiving nodes being spatially separated from said first receiving node wherein each of said second and third receiving nodes comprises a receiving device for receiving said first signal.

4. An underwater navigation system according to claim 3 wherein a two dimensional bearing of said transmitting beacon relative to said first receiving node of said navigation station is determined from timing data of said first signal measured by said first, second and third receiving nodes.

5. An underwater navigation system according to claim 3 wherein said first propagation velocity V₁ is determined from timing data of said first signal measured by said first, second and third receiving nodes.

6. An underwater navigation system according to claim 3 wherein said second and third receiving nodes each further comprise receiving devices for receiving said second signal.

7. An underwater navigation system according to claim 6 wherein a two dimensional bearing of said transmitting beacon relative to said first receiving node of said navigation station is determined from a respective time differential between said first signal and said second signal at said first, second and third receiving nodes, said respective time differential being determined respectively from measured data of said receiving devices of said first, second, and third receiving nodes.

8. An underwater navigation system according to claim 3 further comprising a fourth receiving node.

9. An underwater navigation system according to claim 8 wherein a three dimensional direction of said transmitting beacon relative to said navigation station is determined from measured data of said first, second, third and fourth receiving nodes.

10. An underwater navigation system according to claim 1 wherein said synchronization of said first and second signals is a synchronization of the phase of each of said signals.

11. An underwater navigation system according to claim 1 wherein said synchronization of said first and second signals is a synchronization of a timing event encoded in each of said signals.

12. An underwater navigation system according to claim 1 wherein said first and second signals are pulsed signals of a finite duration.

13. An underwater navigation system according to claim 12 wherein said synchronization of said first and second signals is a synchronization of the time of a leading edge of each of said signals.

14. An underwater navigation system according to claim 1 wherein said time differential of said first and second signals is determined at said first receiving node by the addition of a time delay to said second signal and by the adjustment thereof until a correlation of said first and second signals reaches a maximum.

15. An underwater navigation system according to claim 1 wherein said first and second signals are transmitted using carrier signals having the same frequency.

16. An underwater navigation system according to claim 1 wherein said carrier frequency of said first and second signals is in the range from 10 Hz to 10 MHz.

17. An underwater navigation system according to claim 1 wherein said first signal is an acoustic signal and said second signal is an electromagnetic signal.

18. An underwater navigation system according to claim 1 wherein said first and said second signal are both electromagnetic signals.

19. An underwater navigation system according to claim 1 wherein said second signal has a frequency within the visible region of the electromagnetic spectrum.

20. An underwater navigation system according to claim 19 wherein said first signal is an electromagnetic signal having a carrier frequency in the range from 10 Hz to 10 MHz.

21. An underwater navigation system according to claim 19 wherein said first signal is an acoustic signal.

22. An underwater navigation system according to claim 19 wherein said second signal is modulated at a frequency having the same value as a carrier frequency of said first signal.

23. An underwater navigation system according to claim 3 wherein a line extending from said first receiving node to said second receiving node is substantially perpendicular to a line extending from said first receiving node to said third receiving node.

24. An underwater navigation system according to claim 1 wherein said navigating station is a mobile station.

25. An underwater navigation system according to claim 1 wherein said navigating station has a fixed location and said transmitting beacon is mounted on a mobile underwater unit.

26. An underwater navigation system according to claim 1 wherein said transmitting beacon transmits for a given period of time and then shuts down.

27. An underwater navigation system according to claim 1 wherein said transmitting beacon commences transmission after receiving a handshaking signal from said navigating station.

28. An underwater navigation system according to claim 3 wherein said signal receiving devices are omnidirectional devices for receiving said first and/or said second signals.

29. An underwater navigation system according to claim 1 further comprising a plurality of navigating stations each comprising at least one receiving node for receiving said first and said second signals.

30. An underwater navigation system,
said navigation system comprising a plurality of transmitting beacons each transmitting first and second signals, said first and second signals being transmitted in synchronization from each beacon and having respective first and second propagation velocities,
said navigation system further comprising a navigating station comprising a receiving node,
said receiving node comprising a first and a second receiving device for respectively detecting said first and the second signals,
wherein, during use, a time differential between a first signal and a second signal of at least one of said plurality of transmitting beacons is determined from measured data of said first and said second receiving device and wherein a range of said at least one of said plurality of transmitting beacons from said navigating station is determined from said time differential between said first signal and said second signal.

31. An underwater navigation system according to claim 30 wherein each pair of said first and second signals transmitted by each of said plurality of transmitting beacons are transmitted with an identifying property so that that said first and second signals of each of said plurality of transmitting beacons can be distinguished.

32. An underwater navigation system according to claim 31 wherein said identifying property of said first and second signals is the carrier frequency.

33. An underwater navigation system according to claim 31 wherein said identifying property of said first and second signals is in the form of a pre-programmed binary sequence specific to each of said plurality of transmitting beacons.

34. An underwater navigation system according to claim 30 wherein a relative position of said navigating station is determined from signals received from at least three of said plurality of transmitting beacons.
